(19) United States
(12) Patent Application Publication
(10) Pub. No.: US 2004/0143757 A1
(43) Pub. Date: Jul. 22, 2004

(54) Method, system, and computer program product for verifying rule processing for web pages

(76) Inventor: Brian Cheng, Morrisville, NC (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 10/346,678

(22) Filed: Jan. 17, 2003

(51) Int. Cl. H04L 9/00

(52) U.S. Cl. 713/201

(57) ABSTRACT

A method, system, and computer program product for verifying rule processing for web pages is disclosed. The dynamic content (e.g., the rules) of a website is identified and a key is created for that dynamic content. Users of the site are identified and any dynamic content associated with a particular user is verified as being correct. The web content is ignored so that only the rules themselves are analyzed. The resulting file, stripped of the web content, is used to verify that the rules can be successfully processed for each web user, without needing to access the website.

### BACKGROUND OF THE INVENTION

1. Field of the Invention

The present invention relates to data processing systems, and more particularly, to a method and system for verifying the accuracy of requested dynamic web content.

2. Description of the Related Art

The merger of the Internet and commerce to form what is now known worldwide as “E-commerce” has led to the proliferation of the use of the Internet and World Wide Web (“the Web”) for purchases of all kinds. Everything from airline tickets to automobiles to vitamins can be purchased on the Web and such sales have experienced explosive growth.

As E-commerce has developed, software has been developed to allow more creative and financially-rewarding ways to use the Web for advertising and sales. When E-commerce was in its infancy, static web pages were used by a Web Host (e.g., an “E-tailer” hosting a web site) to present Web Users (e.g., potential customers viewing the Web Host's web site) with fixed web pages displaying catalog information, product descriptions, services descriptions, photographs of products and the like. These static web pages were essentially electronic catalogs, containing basically the same information as would be found in a printed catalog, but available via the Web.

Web Hosts and programmers quickly realized that the Web presented numerous opportunities for providing targeted information to Web Users in a way that was impossible with standard printed catalogs. Specifically, dynamic web content became possible, primarily through the development of programming technologies such as JAVA, JSP (Java Server Pages), and ASP (Active Server Pages) and their use of objects that serve as placeholders for dynamic content on web pages.

JAVA is an object-oriented language that satisfied the public's desire to animate and add dynamism to the static web pages of the Internet. Since JAVA is a platform-independent language, software vendors were not limited to a single platform when developing their software. The introduction of JAVA Beans further enhanced the dynamic aspect of web pages. JAVA Beans is an architecture- and platform-neutral Application Programming Interface (API) for creating and using dynamic JAVA components. JAVA and JAVA Beans are well-known technologies. For details and background with respect to JAVA, reference may be made to a typical text, “Just Java,” Second Edition, Peter van der Linden, Sun Microsystems, 1977. JAVA Beans and their common properties and functions are described in detail in the text “Java in a Nutshell,” Second Edition, David Flanigan, O'Reilly and Associates, 1997.

Through the use of dynamic web content, a website designer can tailor the web content delivered to a particular Web User by taking into consideration user information identifying, for example, the likes and dislikes of the user. This user information regarding the Web User can be gleaned from multiple sources, including, for example, past purchase history, “click-stream” data, survey information obtained from electronic questionnaires, and the like. By utilizing this user information, web content that would be desirable to a particular Web User can be displayed when that user visits a particular page, and web content that is unlikely to interest that user can be avoided.

Typically, a web page containing dynamic content contains a static portion that will be seen by all visitors, and one or more dynamic elements in which the dynamic content will be displayed. As an example, a web page for a fictitious retailer, XYZ-Mart, might contain the XYZ-Mart logo, information about the company, and similar generic information, all of which is static and thus will be delivered to all Web Users visiting the XYZ-Mart web site. The XYZ-Mart web site may also have one or more dynamic content “windows” in which would be displayed static content that varies depending on the Web User viewing the page.

Thus, a user who visits the XYZ-Mart web site for the first time might have “welcome information” displayed in a dynamic-content window, while a previously registered user who has indicated an interest in power tools (e.g., by previously having viewed advertising relating to power tools or by having indicated this interest on an electronic questionnaire) can be immediately presented with information pertaining to sales of power tools in the same dynamic-content window when they visit the homepage of XYZ-Mart. A third user, who has previously purchased hiking equipment from the XYZ-Mart website, might be presented with sales information regarding tents, hiking boots, camping equipment, and other similar hiking-related materials in the same dynamic-content window(s) when they visit the same web page.

While enhancing the web experience of the Web User and the financial return for the Web Host, dynamic web pages also increase the complexity of creating and maintaining the website. Since there is more information to display, there are more files to be maintained and a higher likelihood that a request for a particular type of content may result in an error. Accordingly, a significant amount of time is expended checking the website to assure that the content coming back to a particular user is appropriate and accurate for that user. The prior art methods for conducting this checking are time intensive, and thus the generally-accepted practice is to randomly or systematically check only a sample comprising a subset of the entire universe of dynamic content. Obviously, such a piecemeal approach is not as effective as checking all dynamic content; however, to check all dynamic content using the prior art approaches is time- and cost-prohibitive.

Accordingly, it would be desirable to have a method and system for automatically determining, for each user of a website that provides dynamic content, whether or not the content delivered to each user when they enter the site is accurate and appropriate for that user based upon their user information.

### SUMMARY OF THE INVENTION

The present invention comprises a method, system, and computer program product for verifying rule processing for web pages. In accordance with the present invention, the dynamic content (e.g., the rules) of a website is identified and a key is created for that dynamic content. Users of the site are identified and any dynamic content associated with a particular user is verified as being correct. The web content is ignored so that only the rules themselves are analyzed. The resulting file, stripped of the web content, is used to verify that the rules can be successfully processed for each web user, without needing to access the website. The present invention can parse an XML file that holds the rules, the methods called on the rules, and the correct content for the rules. For each rule, the present invention invokes a personalization rules engine and returns the content, and then checks the return content against the correct content.

### BRIEF DESCRIPTION OF THE DRAWINGS

FIG. 1 illustrates a fictitious example of a “Holiday Gift Guide” web page for IBM;

FIG. 2 illustrates the web page illustrated in FIG. 1 as it might appear when accessed by a previous Web User who has indicated an interest in business-related merchandise;

FIG. 3 is a flowchart that illustrates the steps involved in a first prior art method of checking content;

FIG. 4 is a flowchart that illustrates a prior art automated method of checking the accuracy of dynamic content being delivered to a dynamic web page;

FIG. 5 is a flowchart illustrating the steps performed by the present invention to overcome the problems of the prior art;

FIG. 6 illustrates a representative workstation hardware environment in which the present invention may be practiced; and

FIG. 7 illustrates a data processing network 40 in which the present invention may be practiced.

### DETAILED DESCRIPTION OF THE PREFERRED EMBODIMENTS

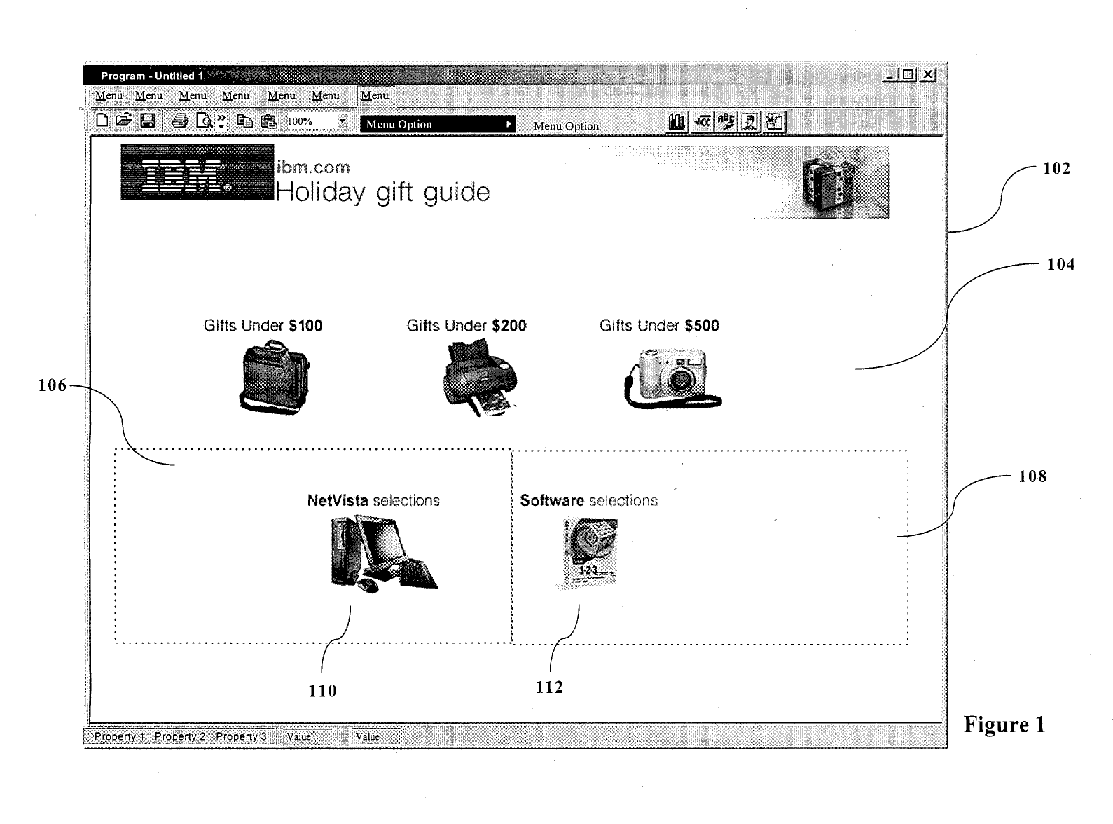

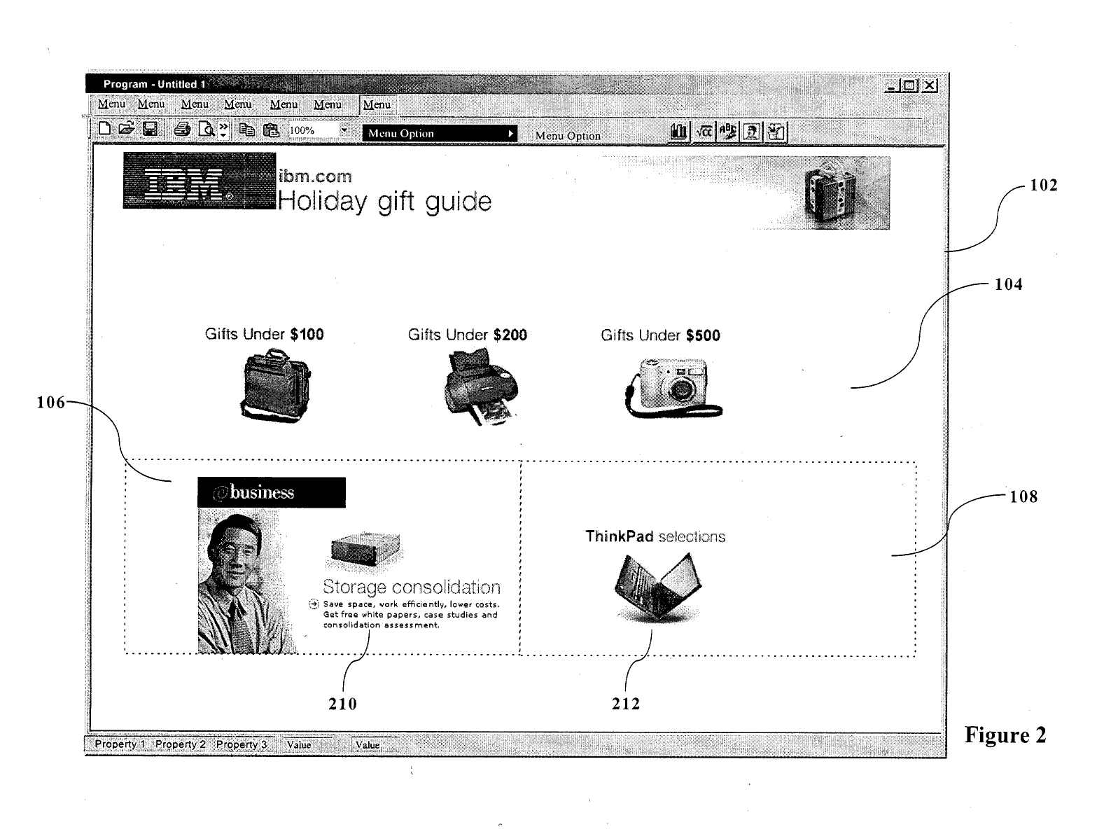

FIGS. 1 and 2 illustrate generally the concept of static content on a website. FIG. 1 illustrates a fictitious example of a “Holiday Gift Guide” web page for IBM. The particular content displayed in a Graphic User Interface (GUI) 102 of FIG. 1 has been tailored to present content to a Web User who has previously expressed an interest in purchasing general consumer items. As is well known, this interest may have been recorded by completion of a questionnaire, by previous purchases made at the site, by click-stream data indicating this interest, and the like.

GUI window 102 includes a static-content area 104 and two dynamic-content areas 106 and 108. In the example of FIG. 1, the static-content area 104 includes the IBM logo, generic information identifying the page, and gift ideas that will likely be of general interest to all consumers.

The content displayed in dynamic-content areas 106 and 108, however, has been selected by the Web Host to display information that is more likely to be of interest to a potential purchaser of general consumer items for personal use. For example, as shown in FIG. 1, dynamic display area 106 gives the user the option of viewing additional pages directed to desktop personal computers sold by IBM, and dynamic-content area 108 displays information 112 regarding software that is available for sale from IBM.

Referring now to FIG. 2, the same web page accessed by a previous Web User who has indicated an interest in business-related merchandise is shown. As can be seen in FIG. 2, the static-content displayed in static-content area 104 of GUI window 102 is identical to that displayed in FIG. 1. However, the dynamic-content 210 and 212 displayed in dynamic-content areas 106 and 108, respectively, has changed and now displays more business-related content (i.e., information regarding data storage solutions and ThinkPad laptops) that is more likely to appeal to a business consumer.

In reality, websites of this nature may be hundreds of pages long with a multitude of different dynamic-content to be displayed to users depending upon their expressed interests. Further, users who are known to the Web Host by having previously visited the website, registered on the website, etc. may number in the hundreds of thousands. This can present a problem when using prior art techniques to confirm that the expected content to be delivered to a particular user based on their interests is actually delivered to them when they hit the site.

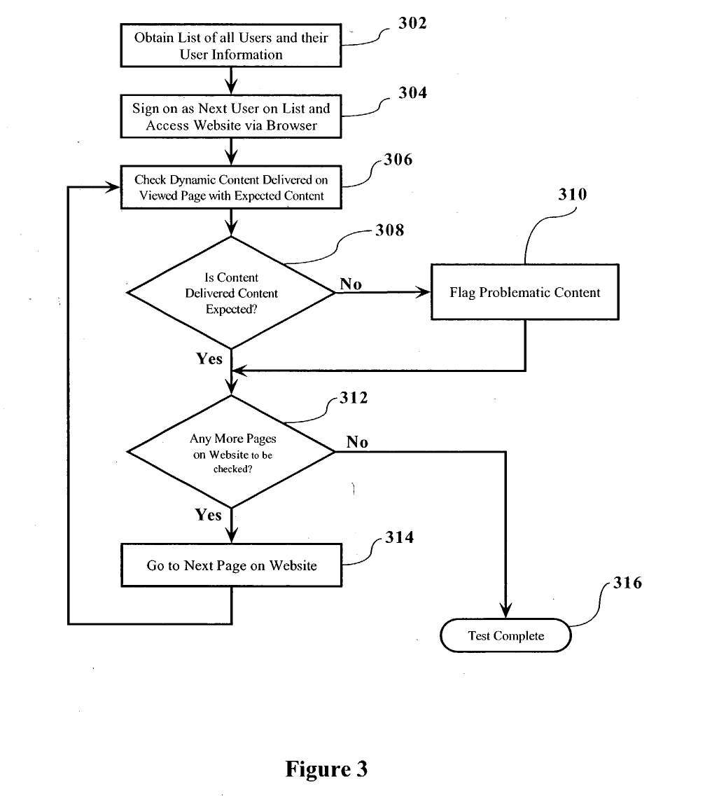

FIG. 3 illustrates the steps involved in a first prior art method of checking content. Referring to FIG. 3, at step 302, the tester/developer who is checking the delivered content on behalf of the web host obtains a list of all users and their user information. At step 304, the tester/developer signs on as the next user on the list (or the first user if this is the first user being tested) and accesses the website via the browser. This requires that all of the HTML or other content be delivered to the tester/developer's browser, including all static-content, which will be the same for each user. At step 306, with knowledge of the interests expressed by the user, the tester/developer manually views the dynamic content delivered on the viewed page and compares it with the expected content. If the content delivered is not the content that is expected, the developer/tester flags the problematic content and the page with which it is associated, and then the process proceeds to step 312. If, at step 308, the content delivered is the content expected, the process proceeds immediately to step 312.

At step 312, a determination is made as to whether or not there are any additional pages on the website to be checked for that user.

If there are no more pages on the website to be checked for the user under test, the process proceeds to step 314. If, however, at step 312, there are additional website pages to be checked, the process proceeds back to step 306 to manually test the next page on the website and repeat the checking process.

At step 314, a manual determination is made as to whether or not there are any more users in the list of users to be checked. If there are additional users to be checked, then the process proceeds back to step 304, where the next user is manually selected and the test process begins again. If, however, at step 314 there are no more additional users to check, then the process proceeds to step 316 and the test process is complete.

As can be seen from the above description, this method is time-consuming and requires significant human interaction. Specifically, a tester/developer must manually go through every page of the website for every user in the list and make sure that the content being delivered is what is desired. As mentioned above, to shorten the process, the standard procedure is to, rather than check for all users, simply check a sampling of the users and make sure that the content being delivered for those users is accurate.

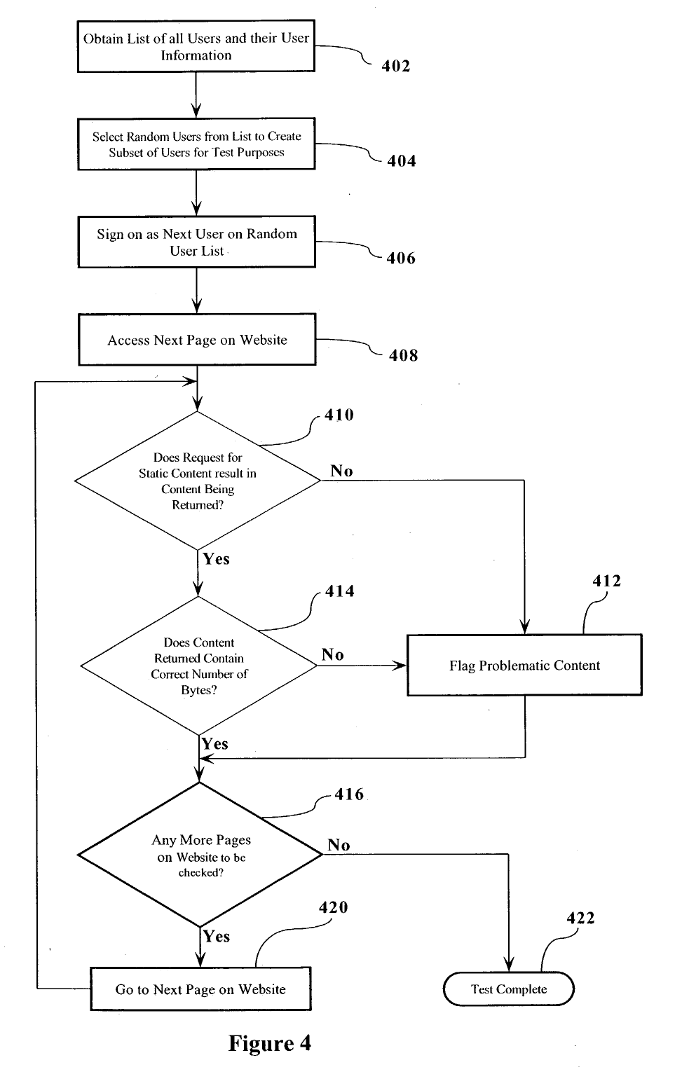

FIG. 4 illustrates a prior art automated method of checking the accuracy of dynamic content being delivered to a dynamic web page. The process is automated by the creation of a macro that steps through the website automatically, for each user, and records the results returned (i.e., the returned HTTP codes) and the size of the returned file. Beginning at step 402, a list of all users and their user information is obtained. If desired, at step 404, a subset of these users can be selected to create a random test-user list. At step 406, the macro causes the browser to sign on to the website as the next user (or first user if this is the first test being performed) in the test user list. At step 408, the macro, using the identity of the user being tested, accesses the next (or first) page on the website. At step 410, a determination is made as to whether or not the request for static content resulted in any content being returned. If the answer is no, then the process proceeds to step 412, where the problematic content and web page is flagged for later consideration and debugging. If, at step 410, it is determined that some web content was returned, then at step 414, a determination is made as to the size of the file returned (e.g., the number of bytes in the returned file). If the number of bytes returned matches the number of bytes expected, the process proceeds to step 416, described further below. If, however, the incorrect number of bytes is returned, the process proceeds to step 412 and the page/content is identified as problematic.

At step 416, a determination is made as to whether or not there are any more pages on the website to be checked. If there are no additional pages on the website to be checked, the process proceeds to step 420. However, if at step 416 it is determined that there are more pages on the website to be checked, then the process proceeds back to step 408 where it is directed to return to step 410 and check the next page on the website by the same process described above.

At step 420, a determination is made as to whether or not there are any additional users in the user list that require checking. If there are additional users to check, the process proceeds back to step 406, the next user is obtained, and the testing process proceeds. If, however, at step 420, there are no additional users to be, checked, the process proceeds to step 422, and the process is complete.

The method described in FIG. 4, while automating the process, has drawbacks. The determination as to whether or not any content has been returned is based on the HTTP code returned. For example, a code “200” may be returned indicating that content was received successfully. While this does indicate the content was received, it provides no indication as to what that content contained.

The checking of the size of the file provides a way of minimizing the possibility that the returned content is incorrect content. However, if incorrect content is returned that is of the same file size as the expected file size, the test of FIG. 4 will appear to have indicated that the content being returned is correct when, in fact, it is not. Thus, for example, a careful hacker could thwart the prior art system by replacing the desired dynamic content with different content of exactly the same size.

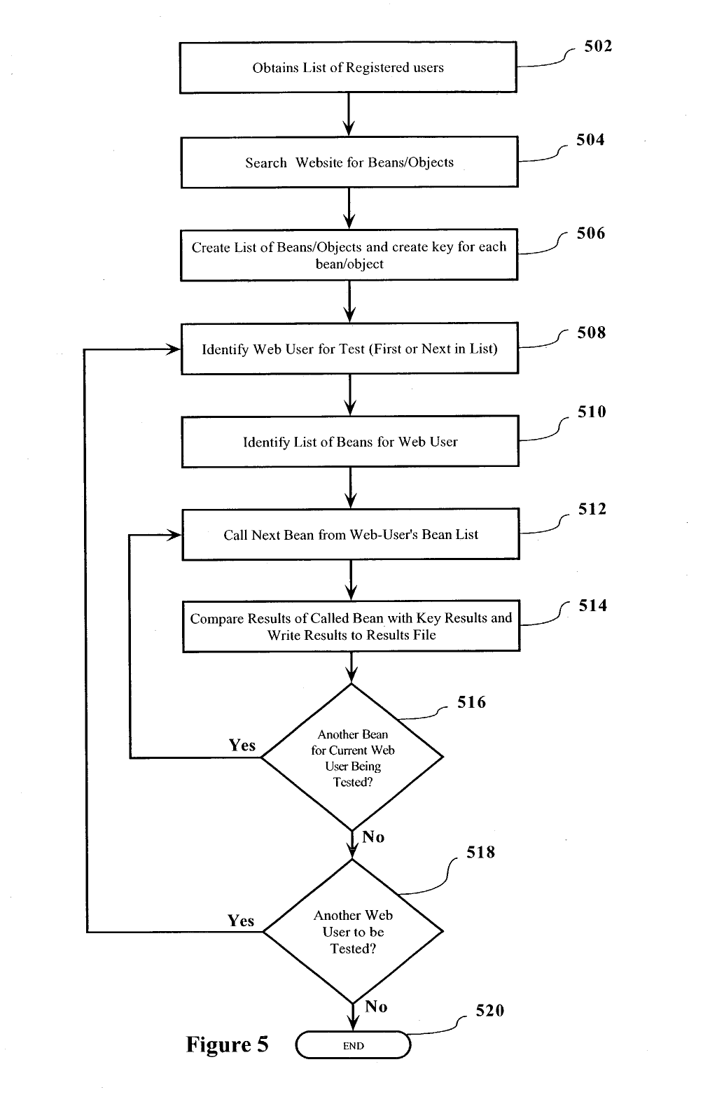

FIG. 5 is a flowchart illustrating the steps performed by the present invention to overcome the problems of the prior art. Referring to FIG. 5, at step 502, a list of registered users and/or users that have previously visited the website and for which data has been retained is created, along with the user characteristic data associated with each user. This can be accomplished using any known technique for searching data and deriving a list, e.g., by tagging user names with a known tag and then searching for the tag and compiling a list of all entries with the tag.

At step 504, the tester/developer searches the entire website for any JAVA Beans (or other objects identifying dynamic content to be delivered) and at step 506, a list is created for each Bean/object and a key is created. The searching process can be conducted using known search techniques (e.g., word searching). For example, JSPs, ASPs, and other objects have unique file extensions that identify them as such. A JSP will have an extension “.jsp” and an ASP will have an extension “.asp”. This process is repeated for all directories and subdirectories, without the need to load or display any of the HTML code that is unnecessary for this determination.

The key is developed and is used for comparing with the retrieved content later in the test. The key can comprise a simple list identifying each element of dynamic content by name and location within the file, and a copy of the code comprising the dynamic content. This key is stored for later use, as discussed in more detail below. It is understood that the key could be created at any time and as often as desired, i.e., each time the list of registered users has been updated. In a preferred embodiment, after the website has been searched and the list of dynamic content has been created, the user may be queried to determine if a key should be created. If the user answers in the affirmative, the key is created and used for content checking the next time it is requested. If the user answers in the negative, the process proceeds directly to the content-checking step.

At step 508, a first web user for testing is identified from the list of registered/previously visiting users. For example, users can be selected alphabetically, or in the order in which they appear in the list, or by any known method for selection from a list. At step 510, based upon the stored information regarding the user being tested, a list of Beans/objects for that user is identified. The process for identifying the list of Beans/objects can be any known process for searching code, such as the process described above with respect to steps 504 and 506. The primary difference between the steps of 504 and 506 and the steps 508 and 510 are that in steps 508 and 510, the list of Beans/objects are correlated to a particular user. The steps 504 and 506 need only be run once to create a master list of all Beans and other objects for creation of the key, regardless of the user that may be using them.

At step 512, the next Bean/object (or the first bean/object) from the web user's Bean/object list is called, and at step 514, the results of the called Bean/object is compared with the key results for that Bean/object and the results of the comparison are written to a results file. The comparison can be a line-by-line, character-by-character comparison, or an object-by-object comparison, or any other know method for automatically comparing computer files. This results file will contain information both as to matches and non-matches, thereby allowing the tester/developer to identify the Beans/objects that are causing the problems.

At step 516, a determination is made as to whether or not there is another Bean/object to be tested for the current Web User being tested. If not, the process proceeds to step 518; if there are additional Beans/objects for the current Web User being tested, the process proceeds back to step 512 to check the next Bean/object from the Web User's Bean/object list.

At step 518, a determination is made as to whether or not there is another Web User to be tested. If at step 518 there are additional Web Users indicated, the process proceeds back to step 508, and that User is then tested as above. If, however, at step 518 it is determined that there are no further Web Users to be tested, the process proceeds to step 520 where the process ends.

As a result of the method described above in connection with FIG. 5, every Bean/object for every User will be automatically tested without the need to, for example, deliver unnecessary HTML code or other static data to the tester/developer and, in fact, without the need to have a browser format the content for viewing on a browser at all. Further, since the actual information contained in the Bean/object is compared with the information contained in the Bean/object being delivered, there is a substantive analysis of the content, not just an analysis of whether or not a Bean/object was returned and the size of the Bean/object. In addition, performance of objects can be tested, without having the overhead of rendering static content. Also, the tester/developer can study the results file and quickly identify the location of the problematic areas.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIG. 5 supports combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation being used by the tester/developer. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

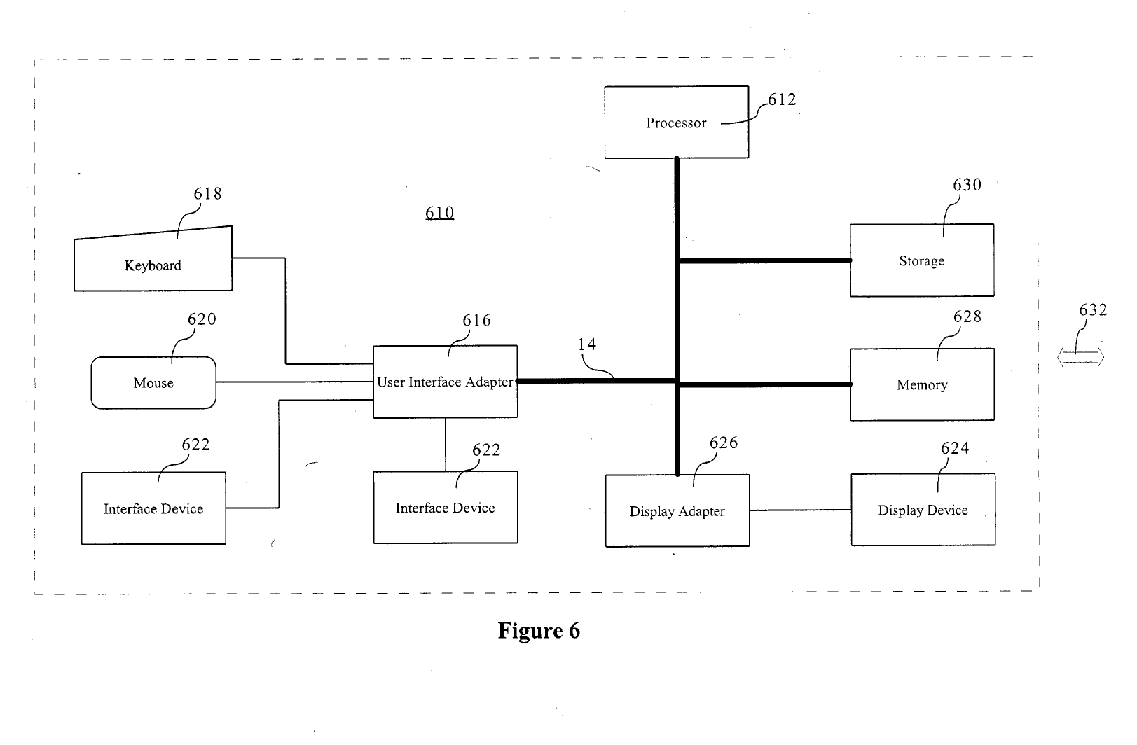

FIG. 6 illustrates a representative workstation hardware environment in which the present invention may be practiced. The environment of FIG. 6 comprises a representative single user computer workstation 610, such as a personal computer, including related peripheral devices. The workstation 610 includes a microprocessor 612 and a bus 614 employed to connect and enable communication between the microprocessor 612 and the components of the workstation 610 in accordance with known techniques. The workstation 610 typically includes a user interface adapter 616, which connects the microprocessor 612 via the bus 614 to one or more interface devices, such as keyboard 618, mouse 620, and/or other interface devices 622, which can be any user interface device, such as a touch sensitive screen, digitized entry pad, etc. The bus 614 also connects a display device 624, such as an LCD screen or monitor, to the microprocessor 612 via a display adapter 626. The bus 614 also connects the microprocessor 612 to memory 628 and long term storage 630 which can include a hard drive, tape drive, etc.

The workstation 610 communicates via a communications channel 632 with other computers or networks of computers. The workstation 610 may be associated with such other computers in a local area network (LAN) or a wide area network, or the workstation 610 can be client in a client/server arrangement with another computer, etc. All of these configurations, as well as the appropriate communications hardware and software, are known in the art.

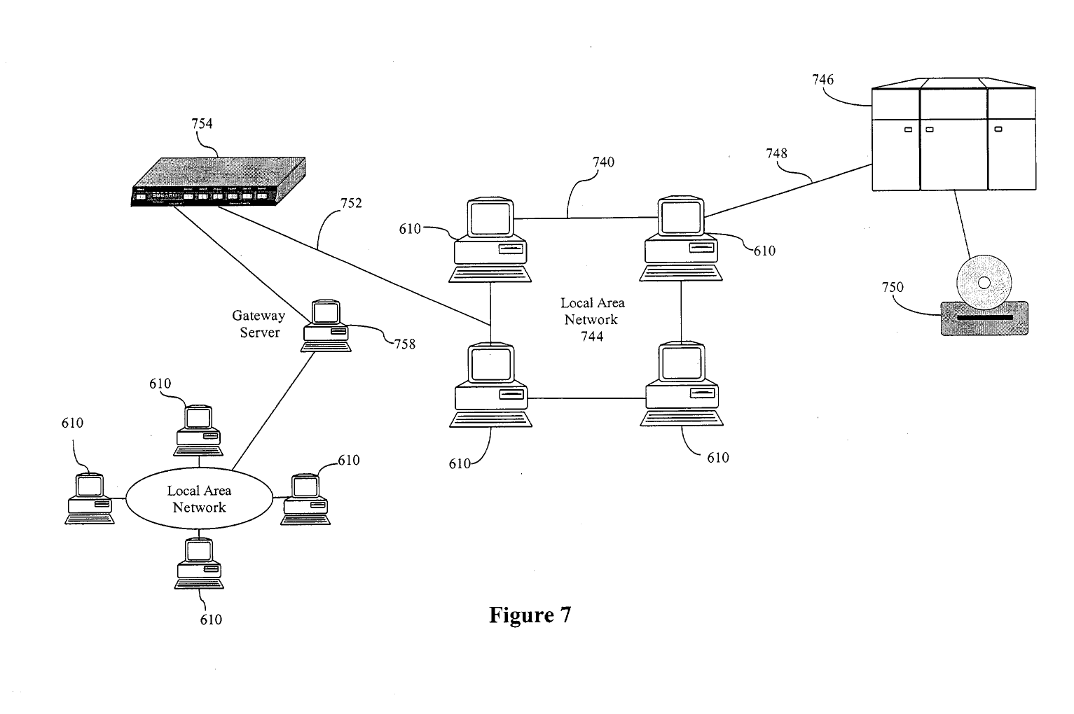

FIG. 7 illustrates a data processing network 740 in which the present invention may be practiced. The data processing network 740 includes a plurality of individual networks, including LANs 742 and 744, each of which includes a plurality of individual workstations 710. Alternatively, as those skilled in the art will appreciate, a LAN may comprise a plurality of intelligent workstations coupled to a host processor.

Still referring to FIG. 7, the data processing network 740 may also include multiple mainframe computers, such as a mainframe computer 746, which may be preferably coupled to the LAN 744 by means of a communications link 748. The mainframe computer 746 may be implemented utilizing an Enterprise Systems Architecture/370, or an Enterprise Systems Architecture/390 computer available from the International Business Machines Corporation (IBM). Depending on the application, a midrange computer, such as an Application System/400 (also known as an AS/400) may be employed. “Enterprise Systems Architecture/370” is a trademark of IBM; “Enterprise Systems Architecture/390”, “Application System/400” and “AS/400” are registered trademarks of IBM.

The mainframe computer 746 may also be coupled to a storage device 750, which may serve as remote storage for the LAN 744. Similarly, the LAN 744 may be coupled to a communications link 752 through a subsystem control unit/communication controller 754 and a communications link 756 to a gateway server 758. The gateway server 758 is preferably an individual computer or intelligent workstation which serves to link the LAN 742 to the LAN 744.

Those skilled in the art will appreciate that the mainframe computer 746 may be located a great geographic distance from the LAN 744, and similarly, the LAN 744 may be located a substantial distance from the LAN 742. For example, the LAN 742 may be located in California, while the LAN 744 may be located in Texas, and the mainframe computer 746 may be located in New York.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of verifying the accuracy of dynamic content requestable from a site, comprising the steps of:
creating a dynamic-content key for the site;
obtaining a list of users of the site and preferences associated with each user in the list;
identifying dynamic content elements associated with each user in the list;
requesting each dynamic content element associated with each user;
comparing the result of each request with the dynamic-content key; and
designating each requested dynamic content element that matches the key as being correct and designating each requested dynamic content element that doesn't match the key as being incorrect.

2. The method of claim 1, wherein said key-creation step comprises at least the steps of:
searching the site to identify all available dynamic content elements;
creating a key-list of all available dynamic content elements; and
creating a key-copy of the code associated with each dynamic content element identified in said key-list.

3. The method of claim 2, wherein said comparing step comprises at least the steps of:
comparing the code of each requested dynamic content element with the key-copy of code corresponding to each;
if the comparison indicates that the code of a requested dynamic content element is identical to its corresponding key-copy of code, designating the requested dynamic content element as correct; and
if the comparison indicates that the code of a requested dynamic content element is not identical to its corresponding key-copy of code, designating the requested dynamic content element as incorrect.

4. The method of claim 3, wherein said site comprises a website.

5. The method of claim 4, wherein said step of obtaining a list of users and preferences associated with each user in the list comprises at least the steps of:
requiring all users of said website to register with the website by submitting registration information; and
storing said submitted registration information.

6. The method of claim 5, wherein said submitted registration information includes the submission of answers to questions soliciting information regarding interests of users registering with the website.

7. The method of claim 4, wherein said step of obtaining a list of users and preferences associated with each user in the list comprises at least the steps of:
requiring all users of said website to accept a cookie prior to being given access to the website; and
storing data regarding the identity and use of said website by said user in said cookie;
reading the stored cookie data when the identity and preferences of a user is desired.

8. A system for verifying the accuracy of dynamic content requestable from a site, comprising:
means for creating a dynamic-content key for the site;
means for obtaining a list of users of the site and preferences associated with each user in the list;
means for identifying dynamic content elements associated with each user in the list;
means for requesting each dynamic content element associated with each user;
means for comparing the result of each request with the dynamic-content key; and
means for designating each requested dynamic content element that matches the key as being correct and designating each requested dynamic content element that doesn't match the key as being incorrect.

9. The system of claim 8, wherein said means for key-creation comprises at least:
means for searching the site to identify all available dynamic content elements;
means for creating a key-list of all available dynamic content elements; and
means for creating a key-copy of the code associated with each dynamic content element identified in said key-list.

10. The system of claim 9, wherein said comparing means comprises at least:
means for comparing the code of each requested dynamic content element with the key-copy of code corresponding to each;
means for designating the requested dynamic content element as correct if the comparison indicates that the code of a requested dynamic content element is identical to its corresponding key-copy of code; and
means for designating the requested dynamic content element as incorrect if the comparison indicates that the code of a requested dynamic content element is not identical to its corresponding key-copy of code.

11. The system of claim 10, wherein said site comprises a website.

12. The system of claim 11, wherein said means for obtaining a list of users and preferences associated with each user in the list comprises at least:
means for requiring all users of said website to register with the website by submitting registration information; and
means for storing said submitted registration information.

13. The system of claim 12, wherein said submitted registration information includes the submission of answers to questions soliciting information regarding interests of users registering with the website.

14. The system of claim 11, wherein said means for obtaining a list of users and preferences associated with each user in the list comprises at least:
means for requiring all users of said website to accept a cookie prior to being given access to the website;
means for storing data regarding the identity and use of said website by said user in said cookie; and
means for reading the stored cookie data when the identity and preferences of a user is desired.

15. A computer program product recorded on computer-readable medium for verifying the accuracy of dynamic content requestable from a site, comprising:
computer-readable means for creating a dynamic-content key for the site;
computer-readable means for obtaining a list of users of the site and preferences associated with each user in the list;
computer-readable means for identifying dynamic content elements associated with each user in the list;
computer-readable means for requesting each dynamic content element associated with each user;
computer-readable means for comparing the result of each request with the dynamic-content key; and
computer-readable means for designating each requested dynamic content element that matches the key as being correct and designating each requested dynamic content element that doesn't match the key as being incorrect.

16. The computer program product of claim 15, wherein said computer-readable means for key-creation comprises:
computer-readable means for searching the site to identify all available dynamic content elements;
computer-readable means for creating a key-list of all available dynamic content elements; and
computer-readable means for creating a key-copy of the code associated with each dynamic content element identified in said key-list.

17. The computer program product of claim 16, wherein said computer-readable means for comparing comprises at least:
computer-readable means for comparing the code of each requested dynamic content element with the key-copy of code corresponding to each;
computer-readable means for designating the requested dynamic content element as correct if the comparison indicates that the code of a requested dynamic content element is identical to its corresponding key-copy of code; and
computer-readable means for designating the requested dynamic content element as incorrect if the comparison indicates that the code of a requested dynamic content element is not identical to its corresponding key-copy of code.

18. The computer program product of claim 17, wherein said site comprises a website.

19. The computer program product of claim 18, wherein said computer-readable means for obtaining a list of users and preferences associated with each user in the list comprises at least:
computer-readable means for requiring all users of said website to register with the website by submitting registration information; and
computer-readable means for storing said submitted registration information.

20. The computer program product of claim 19, wherein said submitted registration information includes the submission of answers to questions soliciting information regarding interests of users registering with the website.

21. The computer program product of claim 18, wherein said computer-readable means for obtaining a list of users and preferences associated with each user in the list comprises at least:
computer-readable means for requiring all users of said website to accept a cookie prior to being given access to the website;
computer-readable means for storing data regarding the identity and use of said website by said user in said cookie; and
computer-readable means for reading the stored cookie data when the identity and preferences of a user is desired.
